(19) United States
(12) Patent Application Publication
(10) Pub. No.: US 2011/0223973 A1
(43) Pub. Date: Sep. 15, 2011

(54) ONE-TOUCH DIAL

(76) Inventors: Jisheng LI, Los Altos, CA (US); Lei Wang, Shanghai (CN)

(21) Appl. No.: 13/003,075

(22) PCT Filed: Aug. 18, 2009
(86) PCT No.: PCT/US09/54120

§ 371 Date: May 19, 2011

Related U.S. Application Data
(60) Provisional application No. 61/089,835, filed on Aug. 18, 2008.
(60) Provisional application No. 61/089,836, filed on Aug. 18, 2008.

(51) Int. Cl. H04B 1/38; G06F 3/041

(52) U.S. Cl. 455/564; 345/173

(57) ABSTRACT

Apparatus having corresponding methods, and tangible computer-readable media embodying instructions executable by a computer to perform the methods, comprise: a touch panel; a character recognition module to recognize a character drawn on the touch panel; a contact module to select a contact, from a contact list containing a plurality of the contacts, based on the character recognized by the character recognition module, automatically when the character recognition module recognizes the character drawn on the touch panel.

### CROSS-REFERENCE TO RELATED APPLICATIONS

This application claims benefit of U.S. Provisional Patent Application Ser. No. 61/089,835, filed Aug. 18, 2008, and Ser. No. 61/089,836, filed Aug. 18, 2008, the disclosures thereof incorporated by reference herein in their entirety.

### FIELD

The present disclosure relates generally to communication devices such as telephones. More particularly, the present disclosure relates to dialing and contact lookup features for such devices.

### BACKGROUND

Modern telephones, both wired and wireless, now include many features for the convenience of users. One such feature, called speed dial, enables a user to associate a frequently-called telephone number with a single digit. When that digit is pressed on the telephone keypad for a given interval, the telephone automatically dials the associated telephone number. However, telephones have now been introduced that have no keypad, but instead have only a touchpad.

### SUMMARY

In general, in one aspect, an embodiment features an apparatus comprising: a touch panel; a character recognition module to recognize a character drawn on the touch panel; a contact module to select a contact, from a contact list containing a plurality of the contacts, based on the character recognized by the character recognition module, automatically when the character recognition module recognizes the character drawn on the touch panel.

Embodiments of the apparatus can include one or more of the following features. Some embodiments comprise a communication module to initiate a communication link, with the contact selected by the contact module, automatically when the contact module selects the contact. Some embodiments comprise a display, wherein the display remains off while the character recognition module recognizes the character drawn on the touch panel, the contact module selects the contact, and the communication module initiates the communication link. Some embodiments comprise a display to display the contact list, and to indicate the contact selected by the contact module, automatically when the contact module selects the contact from the contact list; and a communication module to initiate a communication link, with one of the contacts, automatically when the touch panel receives a selection of the one of the contacts. Some embodiments comprise a motion sensor to cause the apparatus to enter a character recognition mode based on motion of the apparatus; wherein the character recognition module recognizes the character drawn on the touch panel only when the apparatus is in the character recognition mode. Some embodiments comprise a timeout module to cause the apparatus to leave the character recognition mode when the character recognition module does not recognize the character drawn on the touch panel within a predetermined interval. Some embodiments comprise a sleep module to cause the apparatus to enter a sleep mode when the timeout module causes the apparatus to leave the character recognition mode.

In general, in one aspect, an embodiment features a method comprising: recognizing a character drawn on a touch panel of a device; and selecting a contact, from a contact list containing a plurality of the contacts, based on the character, automatically when the character is recognized.

Embodiments of the method can include one or more of the following features. Some embodiments comprise initiating a communication link, with the selected contact, automatically when the contact is selected. Some embodiments comprise keeping a display of the device off while the character is drawn and recognized, while the contact is selected, and while the communication link is initiated. Some embodiments comprise displaying the contact list on a display of the device, and indicating the selected contact, automatically when the contact is selected from the contact list; and initiating a communication link, with one of the contacts, automatically when the touch panel receives a selection of the one of the contacts. Some embodiments comprise causing the device to enter a character recognition mode based on motion of the device; and recognizing the character drawn on the touch panel only when the device is in the character recognition mode. Some embodiments comprise causing the device to leave the character recognition mode when the character drawn on the touch panel is not recognized within a predetermined interval. Some embodiments comprise causing the device to enter a sleep mode when the device leaves the character recognition mode.

In general, in one aspect, an embodiment features tangible computer-readable media embodying instructions executable by a computer to perform a method comprising: recognizing a character drawn on a touch panel of a device; and selecting a contact, from a contact list containing a plurality of the contacts, based on the character, automatically when the character is recognized.

Embodiments of the tangible computer-readable media can include one or more of the following features. In some embodiments, the method further comprises: initiating a communication link, with the selected contact, automatically when the contact is selected. In some embodiments, the method further comprises: keeping a display of the device off while the character is drawn and recognized, while the contact is selected, and while the communication link is initiated. In some embodiments, the method further comprises: causing a display of the device to display the contact list and indicate the selected contact, automatically when the contact is selected from the contact list; and initiating a communication link, with one of the contacts, automatically when the touch panel receives a selection of the one of the contacts. In some embodiments, the method further comprises: causing the device to enter a character recognition mode based on motion of the device; and recognizing the character drawn on the touch panel only when the device is in the character recognition mode. In some embodiments, the method further comprises: causing the device to leave the character recognition mode when the character drawn on the touch panel is not recognized within a predetermined interval. In some embodiments, the method further comprises: causing the device to enter a sleep mode when the device leaves the character recognition mode.

The details of one or more implementations are set forth in the accompanying drawings and the description below. Other features will be apparent from the description and drawings, and from the claims.

### DESCRIPTION OF DRAWINGS

FIG. 1 shows elements of a telephone system according to some embodiments of the present disclosure.

FIG. 2 shows a process for the telephone of FIG. 1 for a one-touch dial power-saving profile according to some embodiments of the present disclosure.

FIG. 3 shows a process for the telephone of FIG. 1 for a one-touch dial display profile according to some embodiments of the present disclosure.

FIG. 4 shows a process for the telephone of FIG. 1 for a one-touch dial power-on profile according to some embodiments of the present disclosure.

FIG. 5 shows a process for the telephone of FIG. 1 for a fast contact lookup profile according to some embodiments of the present disclosure.

The leading digit(s) of each reference numeral used in this specification indicates the number of the drawing in which the reference numeral first appears.

### DETAILED DESCRIPTION

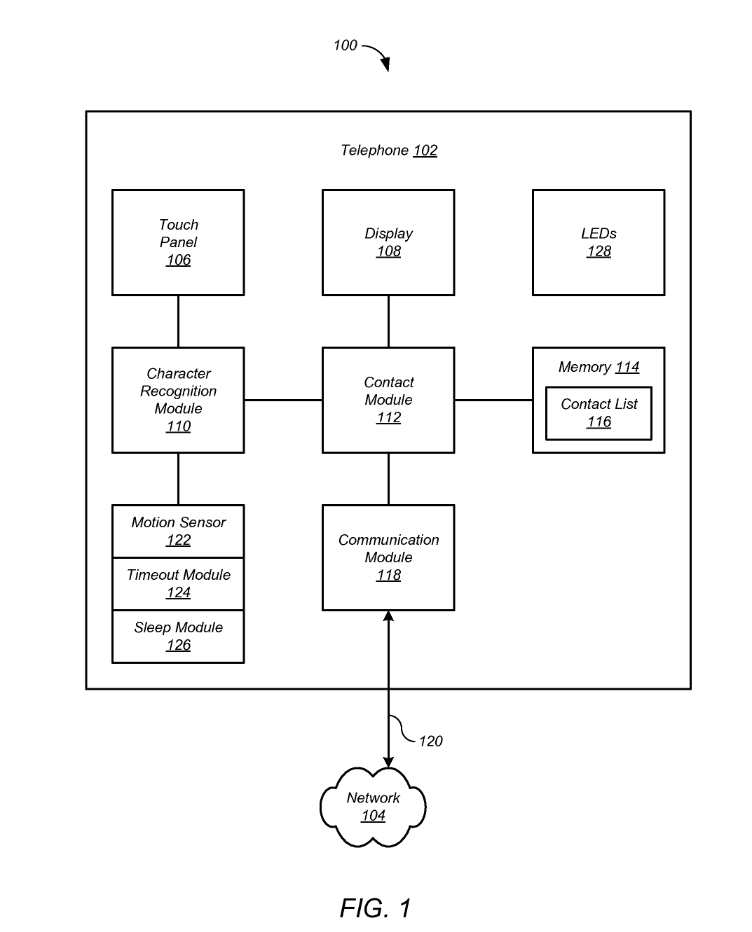

Embodiments of the present disclosure provide one-touch dial and fast contact lookup features for telephones having a touchpad. FIG. 1 shows elements of a telephone system 100 according to some embodiments of the present disclosure. Although in the described embodiments, the elements of telephone system 100 are presented in one arrangement, other embodiments may feature other arrangements, as will be apparent to one skilled in the relevant arts based on the disclosure and teachings provided herein. For example, the elements of telephone system 100 can be implemented in hardware, software, or combinations thereof.

Referring to FIG. 1, telephone system 100 includes a telephone 102 and a network 104. Telephone 102 includes a touch panel 106, a display 108, a character recognition module 110 to recognize characters drawn on touch panel 106, a contact module 112 to select contacts from a contact list 116 stored in a memory 114 based on characters recognized by character recognition module 110, a communication module 118 to initiate communication links 120 over network 104, a motion sensor 122, a timeout module 124, and a sleep module 126. Telephone 102 can also include a light-emitting diode (LED) 128.

Network 104 can be implemented as any sort of telephone network, including wired public switched telephone network (PSTN) networks, wireless networks, data networks such as the Internet, and the like. But while embodiments of the present disclosure are described with respect to telephones and telephone networks, they are equally applicable to other sorts of communication devices, networks, direct links and the like.

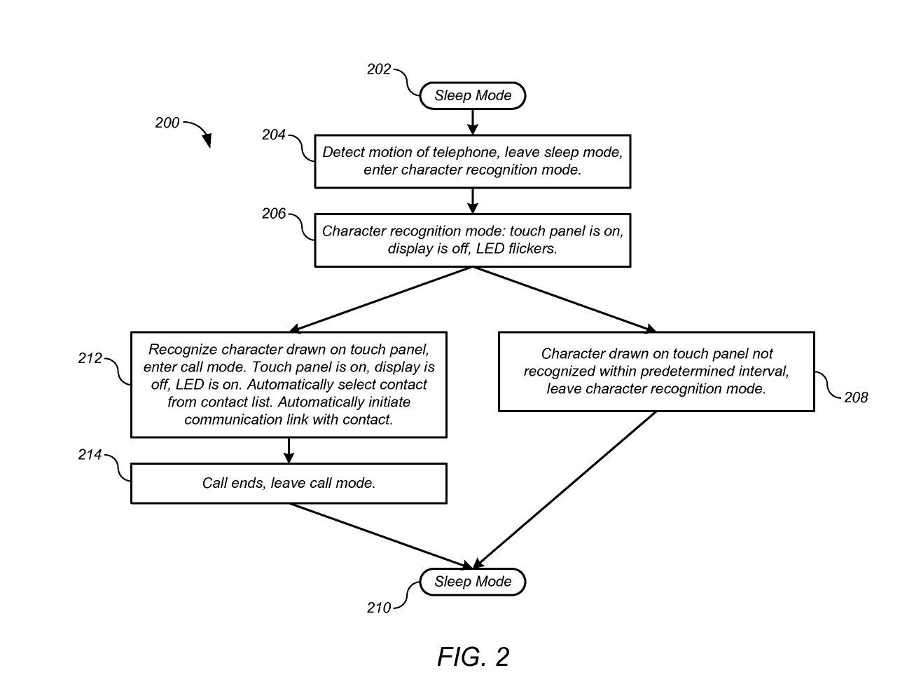

FIG. 2 shows a process 200 for telephone 102 of FIG. 1 for a one-touch dial power-saving profile according to some embodiments of the present disclosure. Although in the described embodiments, the elements of the disclosed processes are presented in one arrangement, other embodiments may feature other arrangements, as will be apparent to one skilled in the relevant arts based on the disclosure and teachings provided herein. For example, in various embodiments, some or all of the steps of the disclosed processes can be executed in a different order, concurrently, and the like.

Referring to FIG. 2, process 200 begins with telephone 102 in sleep mode (step 202), which is controlled by sleep module 126. The sleep mode can be implemented in any manner, and generally involves deactivation of one or more elements of telephone 102 such as display 108, touch panel 106, and the like, as is well-known.

A user can wake telephone 102 by shaking For example, when telephone 102 is shaken twice, motion sensor 122 detects the motion of telephone 102, and in response causes telephone 102 to leave sleep mode, and to enter character recognition mode (step 204). It is possible that motion sensor 122 will fail to wake telephone 102. In some embodiments, a button can be provided to wake telephone 102.

In character recognition mode according to the one-touch dial power-saving profile, touch panel 106 is on, display 108 is off, and LED 128 flickers to indicate character recognition mode is active (step 206). In character recognition mode, character recognition module 110 can recognize a character drawn on touch panel 106, for example with a finger, stylus, or the like. In the described embodiments, characters drawn on touch panel 106 are recognized only when telephone 102 is in character recognition mode.

If character recognition module 110 does not recognize the character drawn on touch panel 106 within a predetermined interval, timeout module 124 causes telephone 102 to leave character recognition mode (step 208), and to enter sleep mode (step 210). But if character recognition module 110 recognizes the character drawn on touch panel 106 within the predetermined interval, then telephone 102 enters call mode (step 212). In call mode according to the one-touch dial power-saving profile, touch panel 106 is on, display 108 is off, and LED 128 is on to indicate call mode is active. In addition, contact module 112 automatically selects a contact from contact list 116 based on the character recognized by character recognition module 110, and a communication module 118 automatically initiates a communication link 120 with the contact selected by contact module 112. In the described embodiments, communication link 120 can include a voice call, a Short Message Service (SMS) message, a text message, an email, or the like. When the call ends, telephone 102 leaves call mode (step 214), and sleep module 126 causes telephone 102 to enter sleep mode (step 210).

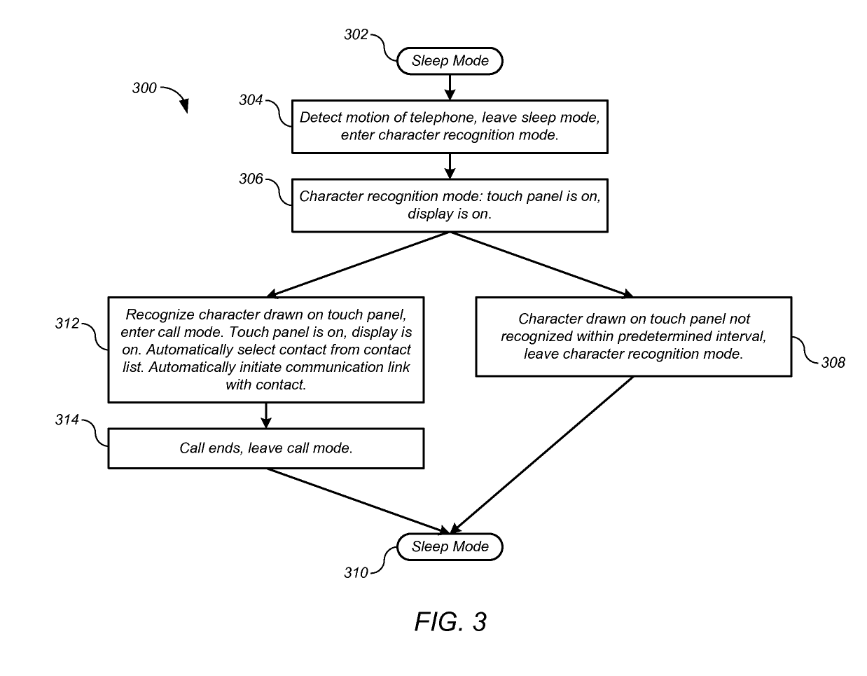

FIG. 3 shows a process 300 for telephone 102 of FIG. 1 for a one-touch dial display profile according to some embodiments of the present disclosure. Referring to FIG. 3, process 300 begins with telephone 102 in sleep mode (step 302), which is controlled by sleep module 126. The sleep mode can be implemented in any manner, and generally involves deactivation of one or more elements of telephone 102 such as display 108, touch panel 106, and the like, as is well-known.

A user can wake telephone 102 by shaking. For example, when telephone 102 is shaken twice, motion sensor 122 detects the motion of telephone 102, and in response causes telephone 102 to leave sleep mode, and to enter character recognition mode (step 304). In character recognition mode according to the one-touch dial display profile, touch panel 106 is on, and display 108 is on to indicate character recognition mode is active by showing a character recognition display (step 306). In character recognition mode, character recognition module 110 can recognize a character drawn on touch panel 106, for example with a finger, stylus, or the like.

If character recognition module 110 does not recognize the character drawn on touch panel 106 within a predetermined interval, timeout module 124 causes telephone 102 to leave character recognition mode (step 308), and to enter sleep mode (step 310). But if character recognition module 110 recognizes the character drawn on touch panel 106 within the predetermined interval, then telephone 102 enters call mode (step 312). In call mode according to the one-touch dial display profile, touch panel 106 is on, and display 108 is on to indicate call mode is active. In some embodiments, display 108 shows the character as it is drawn, and confirms the character on recognition by showing a stored version of the character. In addition, contact module 112 automatically selects a contact from contact list 116 based on the character recognized by character recognition module 110, and communication module 118 automatically initiates a communication link 120 with the contact selected by contact module 112. When the call ends, telephone 102 leaves call mode (step 314), and sleep module 126 causes telephone 102 to enter sleep mode (step 310).

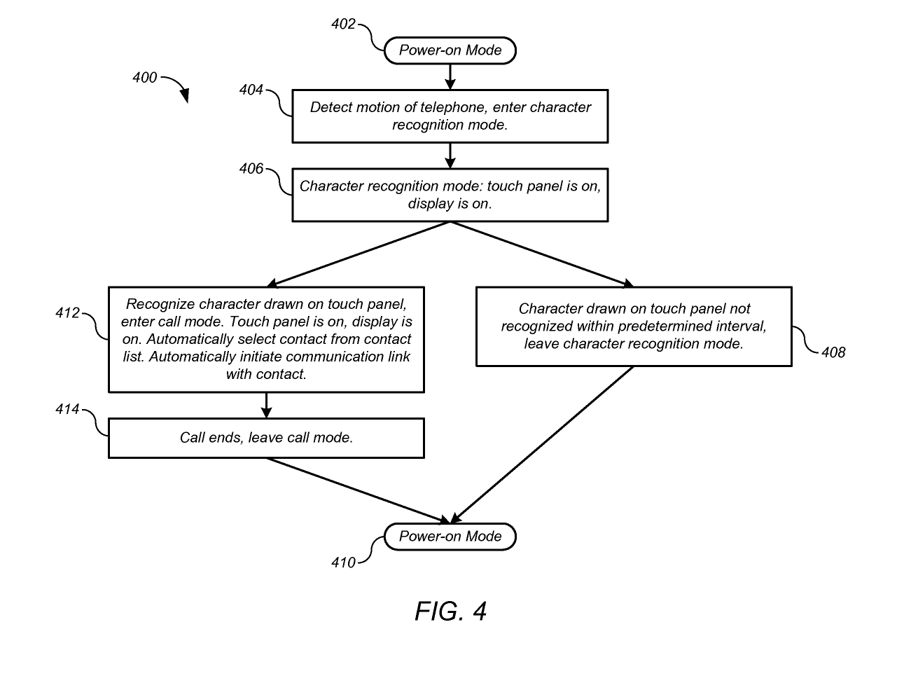

FIG. 4 shows a process 400 for telephone 102 of FIG. 1 for a one-touch dial power-on profile according to some embodiments of the present disclosure. Referring to FIG. 4, process 400 begins with telephone 102 in power-on mode (step 402). In power-on mode, a user can cause telephone 102 to enter character recognition mode by shaking. For example, when telephone 102 is shaken twice, motion sensor 122 detects the motion of telephone 102, and in response causes telephone 102 to enter character recognition mode (step 404). In character recognition mode according to the one-touch dial power-on profile, touch panel 106 is on, and display 108 is on to indicate character recognition mode is active by showing a character recognition display (step 406). In character recognition mode, character recognition module 110 can recognize a character drawn on touch panel 106, for example with a finger, stylus, or the like.

If character recognition module 110 does not recognize the character drawn on touch panel 106 within a predetermined interval, timeout module 124 causes telephone 102 to leave character recognition mode (step 408), and to return to power-on mode (step 410). But if character recognition module 110 recognizes the character drawn on touch panel 106 within the predetermined interval, then telephone 102 enters call mode (step 412). In call mode according to the one-touch dial power-on profile, touch panel 106 is on, and display 108 is on to indicate call mode is active. In some embodiments, display 108 shows the character as it is drawn, and confirms the character on recognition by showing a stored version of the character. In addition, contact module 112 automatically selects a contact from contact list 116 based on the character recognized by character recognition module 110, and communication module 118 automatically initiates a communication link 120 with the contact selected by contact module 112. When the call ends, telephone 102 leaves call mode (step 414), and returns to power-on mode (step 410).

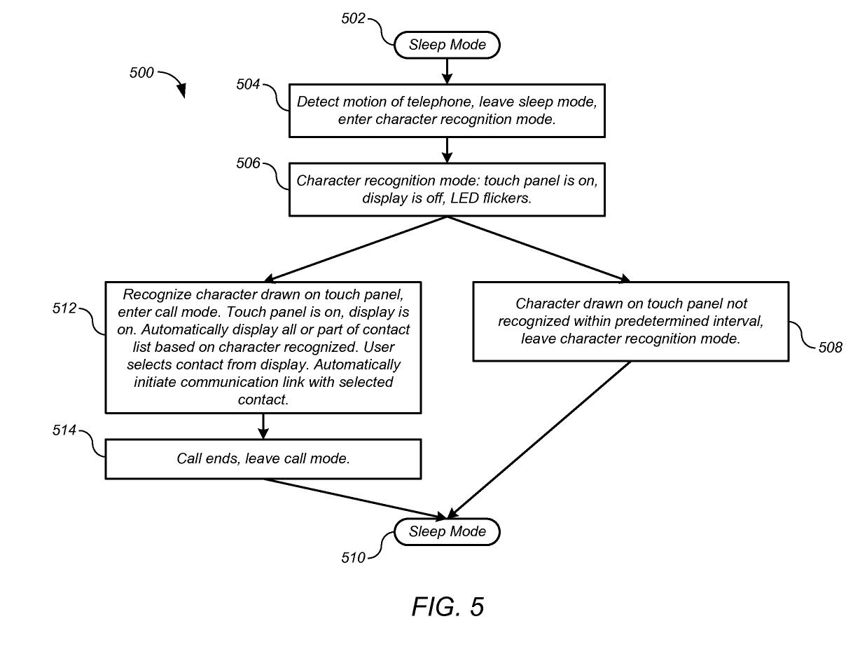

FIG. 5 shows a process 500 for telephone 102 of FIG. 1 for a fast contact lookup profile according to some embodiments of the present disclosure. Referring to FIG. 5, process 500 begins with telephone 102 in sleep mode (step 502), which is controlled by sleep module 126. The sleep mode can be implemented in any manner, and generally involves deactivation of one or more elements of telephone 102 such as display 108, touch panel 106, and the like, as is well-known.

A user can wake telephone 102 by shaking. For example, when telephone 102 is shaken twice, motion sensor 122 detects the motion of telephone 102, and in response causes telephone 102 to leave sleep mode, and to enter character recognition mode (step 504). In character recognition mode according to the fast contact lookup profile, touch panel 106 is on, and display 108 is on to indicate character recognition mode is active by showing a character recognition display (step 506). In character recognition mode, character recognition module 110 can recognize a character drawn on touch panel 106, for example with a finger, stylus, or the like.

If character recognition module 110 does not recognize the character drawn on touch panel 106 within a predetermined interval, timeout module 124 causes telephone 102 to leave character recognition mode (step 508), and to enter sleep mode (step 510). But if character recognition module 110 recognizes the character drawn on touch panel 106 within the predetermined interval, then telephone 102 enters call mode (step 512). If the character recognized is a digit, telephone 102 leaves the fast contact lookup profile, and enters one of the one-touch dial profiles described above. But if the character recognized is a letter, telephone 102 continues in the fast contact lookup profile.

In call mode according to the fast contact lookup profile, touch panel 106 is on and display 108 is on to indicate call mode is active. In addition, display 108 automatically displays all or part of contact list 116 based on the character recognized. For example, if the character recognized is a “D,” then display 108 displays the entries in contact list 116 that start with the letter “D.” A user can then select a contact from the displayed contacts, or cancel the operation using touch panel 106.

If the user selects a contact, communication module 118 automatically initiates a communication link 120 with the selected contact. When the call ends, telephone 102 leaves call mode (step 514), and sleep module 126 causes telephone 102 to enter sleep mode (step 510).

A number of profiles have been described for telephone 102. It should be understood that features and functions of these profiles can be interchanged and modified to created additional profiles without undue experimentation after reading this disclosure.

Embodiments of the disclosure can be implemented in digital electronic circuitry, or in computer hardware, firmware, software, or in combinations of them. Embodiments of the disclosure can be implemented in a computer program product tangibly embodied in a machine-readable storage device for execution by a programmable processor; and method steps of the disclosure can be performed by a programmable processor executing a program of instructions to perform functions of the disclosure by operating on input data and generating output. The disclosure can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

A number of implementations of the disclosure have been described. Nevertheless, it will be understood that various modifications may be made without departing from the spirit and scope of the disclosure. Accordingly, other implementations are within the scope of the following claims.

What is claimed is:

1. An apparatus comprising:
a touch panel;
a character recognition module to recognize a character drawn on the touch panel;
a contact module to select a contact, from a contact list containing a plurality of the contacts, based on the character recognized by the character recognition module, automatically when the character recognition module recognizes the character drawn on the touch panel.

2. The apparatus of claim 1, further comprising:
a communication module to initiate a communication link, with the contact selected by the contact module, automatically when the contact module selects the contact.

3. The apparatus of claim 2, further comprising:
a display, wherein the display remains off while the character recognition module recognizes the character drawn on the touch panel, the contact module selects the contact, and the communication module initiates the communication link.

4. The apparatus of claim 1, further comprising:
a display to display the contact list, and to indicate the contact selected by the contact module, automatically when the contact module selects the contact from the contact list; and
a communication module to initiate a communication link, with one of the contacts, automatically when the touch panel receives a selection of the one of the contacts.

5. The apparatus of claim 1, further comprising:
a motion sensor to cause the apparatus to enter a character recognition mode based on motion of the apparatus;
wherein the character recognition module recognizes the character drawn on the touch panel only when the apparatus is in the character recognition mode.

6. The apparatus of claim 5, further comprising:
a timeout module to cause the apparatus to leave the character recognition mode when the character recognition module does not recognize the character drawn on the touch panel within a predetermined interval.

7. The apparatus of claim 6, further comprising:
a sleep module to cause the apparatus to enter a sleep mode when the timeout module causes the apparatus to leave the character recognition mode.

8. A method comprising:
recognizing a character drawn on a touch panel of a device; and
selecting a contact, from a contact list containing a plurality of the contacts, based on the character, automatically when the character is recognized.

9. The method of claim 8, further comprising:
initiating a communication link, with the selected contact, automatically when the contact is selected.

10. The method of claim 9, further comprising:
keeping a display of the device off while the character is drawn and recognized, while the contact is selected, and while the communication link is initiated.

11. The method of claim 8, further comprising:
displaying the contact list on a display of the device, and indicating the selected contact, automatically when the contact is selected from the contact list; and
initiating a communication link, with one of the contacts, automatically when the touch panel receives a selection of the one of the contacts.

12. The method of claim 8, further comprising:
causing the device to enter a character recognition mode based on motion of the device; and
recognizing the character drawn on the touch panel only when the device is in the character recognition mode.

13. The method of claim 12, further comprising:
causing the device to leave the character recognition mode when the character drawn on the touch panel is not recognized within a predetermined interval.

14. The method of claim 13, further comprising:
causing the device to enter a sleep mode when the device leaves the character recognition mode.

15. Tangible computer-readable media embodying instructions executable by a computer to perform a method comprising:
recognizing a character drawn on a touch panel of a device; and
selecting a contact, from a contact list containing a plurality of the contacts, based on the character, automatically when the character is recognized.

16. The tangible computer-readable media of claim 15, wherein the method further comprises:
initiating a communication link, with the selected contact, automatically when the contact is selected.

17. The tangible computer-readable media of claim 16, wherein the method further comprises:
keeping a display of the device off while the character is drawn and recognized, while the contact is selected, and while the communication link is initiated.

18. The tangible computer-readable media of claim 15, wherein the method further comprises:
causing a display of the device to display the contact list and indicate the selected contact, automatically when the contact is selected from the contact list; and
initiating a communication link, with one of the contacts, automatically when the touch panel receives a selection of the one of the contacts.

19. The tangible computer-readable media of claim 15, wherein the method further comprises:
causing the device to enter a character recognition mode based on motion of the device; and
recognizing the character drawn on the touch panel only when the device is in the character recognition mode.

20. The tangible computer-readable media of claim 19, wherein the method further comprises:
causing the device to leave the character recognition mode when the character drawn on the touch panel is not recognized within a predetermined interval.

21. The tangible computer-readable media of claim 20, wherein the method further comprises:
causing the device to enter a sleep mode when the device leaves the character recognition mode.
